(19) United States
(12) Patent Application Publication
(10) Pub. No.: US 2018/0026363 A1
(43) Pub. Date: Jan. 25, 2018

(54) Adaptive Antenna Systems for Unknown Operating Environments

(71) Applicant: Google Inc., Mountain View, CA (US)

(72) Inventor: Peter Bevelacqua, Sunnyvale, CA (US)

(73) Assignee: Google Inc., Mountain View, CA (US)

(21) Appl. No.: 15/215,264

(22) Filed: Jul. 20, 2016

(51) Int. Cl. H01Q 3/24; H01Q 7/00; H01Q 13/10; H04L 5/00; H01Q 9/06

(52) U.S. Cl. CPC H01Q 3/24; H04L 5/006; H01Q 9/065; H01Q 13/106; H01Q 7/00

(57) ABSTRACT

Various adaptive antenna systems are presented in which the structure of the antenna is configured to realize different radiation patterns. Such arrangements can include electrically connecting and disconnecting portions of the antenna structure to determine an arrangement that results in a higher signal strength in an unknown operating environment, such as in a home in which wireless devices that communicate with each other may be placed in varying directions with respect to each other.

### BACKGROUND

The “Internet of Things” refers to a vast network of computerized devices and sensors that can transmit and receive data. For example, within a home, many devices may be capable of receiving and transmitting data wirelessly, either directly to another device or via a hub or router. When such devices are installed, little or no thought may be given to the physical orientation of an antenna of the device with respect to the one or more other devices with which communication is desired. As such, the orientation, position, and operating environment of the device may negatively affect the device's ability to wirelessly communicate with a remote wireless device.

### SUMMARY

Various systems and methods are presented relating to adaptive antenna systems. In some embodiments, an adaptive antenna system is presented. The adaptive antenna system may include an adaptive antenna that includes a first radiating element and a second radiating element. The adaptive antenna system can include a switch that electrically connects and disconnects the first radiating element and the second radiating element, wherein a type of antenna of the adaptive antenna varies based on whether the first radiating element is electrically connected with the second radiating element. The adaptive antenna system can include an antenna controller that controls actuation of the switch, wherein a radiation pattern of the adaptive antenna varies at a particular frequency based on the first radiating element and the second radiating element being electrically connected or disconnected via the switch.

Embodiments of such an adaptive antenna system may include one or more of the following features: The type of the adaptive antenna may be a slot antenna when the switch electrically connects the first radiating element with the second radiating element and the adaptive antenna may be a dipole antenna when the switch electrically disconnects the first radiating element from the second radiating element. The system may include a second switch that electrically connects and disconnects the first radiating element and the second radiating element. The type of antenna of the adaptive antenna may vary based on whether the first radiating element is electrically connected with the second radiating element using the first switch, the second switch, both, or neither. The type of the adaptive antenna may a slot antenna when the first switch and the second switch electrically connect the first radiating element with the second radiating element. The type of the adaptive antenna may be a dipole antenna when the first switch and the second switch electrically disconnect the first radiating element from the second radiating element. The type of the adaptive antenna may be a right facing Vivaldi antenna when the first switch electrically connects the first radiating element with the second radiating element but the second switch electrically disconnects the first radiating element from the second radiating element. The type of the adaptive antenna may be a left facing Vivaldi antenna when the second switch electrically connects the first radiating element with the second radiating element but the first switch electrically disconnects the first radiating element from the second radiating element. The type of the adaptive antenna may be a dipole antenna when the switch electrically connects the first radiating element with the second radiating element and the adaptive antenna is a loop antenna when the switch electrically disconnects the first radiating element from the second radiating element. The antenna controller may be configured to: determine a first signal strength when the first radiating element is electrically connected with the second radiating element via the switch; determine a second signal strength when the second radiating element is electrically disconnected from the first radiating element via the switch; compare the first signal strength and the second signal strength to determine the first signal strength is greater; and cause, for at least a period of time, the switch to connect the first radiating element and the second radiating element based on determining the first signal strength is greater. The first antenna element may have a different polarization than the second antenna element.

In some embodiments, an adaptive antenna array is presented. The array may include a first antenna and a second antenna. The array may include a first electrical connection from the first antenna to a transceiver. The array may include a second electrical connection apparatus that connects the second antenna to the transceiver. The second electrical connection apparatus may include a phase control component. The array may include an antenna controller that controls a phase of an electrical signal via the phase control component, wherein a radiation pattern of the adaptive antenna array varies at a particular frequency based on a state of the phase control component.

Embodiments of such an adaptive antenna system may include one or more of the following features: The phase control component may include a first switch, a second switch, a first transmission line, and a second transmission line, wherein the first switch and the second switch electrically connect the second antenna to the transceiver via the first transmission line or the second transmission line based on input from the antenna controller. The second transmission line's length may be greater than the first transmission line's length. The second transmission line's length may introduce a phase delay of approximately 90 degrees as compared to the first transmission line's length at a frequency of approximately 2.4 GHz. The radiation pattern of the adaptive antenna may be at least 5 dBi greater in a first direction when the second transmission line is electrically connected as compared to the first transmission line and the radiation pattern of the adaptive antenna is at least 5 dBi greater in a second direction when the first transmission line is electrically connected as compared to the second transmission line. The phase control component may include an array of capacitors, wherein the antenna controller controls the electrical connection of the array of capacitors between the second antenna and the transceiver. The first electrical connection may include a second phase control component that is present between the first antenna and the transceiver. The antenna controller may be configured to: determine a first signal strength when phase control component is set to a first mode; determine a second signal strength when the phase control component is set to a second mode; compare the first signal strength and the second signal strength to determine the first signal strength is greater; and cause, for at least a period of time, the phase control component to be set to the first mode.

An adaptive antenna system may be presented that include an adaptive antenna, which includes a first radiating element having a first length, wherein the first length of the first radiating element corresponds to a first harmonic of a frequency; and a second radiating element having a second length, wherein the second length of the second radiating element corresponds to a second or higher harmonic of the frequency. The system may further include a switch that alternatively connects a transceiver with the first radiating element or the second radiating element, wherein the transceiver transmits or receives at the frequency. The system may further include an antenna controller that controls actuation of the switch between the first radiating element and the second radiating element, wherein a radiation pattern varies at a particular frequency based on whether the first radiating element or the second radiating element is electrically connected with the transceiver via the switch.

Embodiments of such a system may further include one or more of the following features: The operating frequency may be 2.4 GHz. The second length of the second radiating element may correspond to a third harmonic of the frequency. The antenna control may be configured to: determine a first signal metric when the first radiating element is electrically connected with the transceiver via the switch; determine a second signal metric when the second radiating element is electrically connected with the transceiver via the switch; compare the first signal metric and the second signal metric to determine if the first signal strength is greater; and cause, for at least a period of time, the switch to connect the transceiver with the first radiating element based on determining the first signal metric is greater. The signal metric may be selected from the group consisting of: received signal strength (RSSI), signal to noise ratio (SNR), and data throughput.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates a block diagram of an embodiment of an adaptive antenna system.

FIG. 1B illustrates a block diagram of an embodiment of an adaptive antenna system that uses multiple switches.

FIG. 2A illustrates an embodiment of an adaptive antenna system that electrically connects and electrically disconnects antenna elements.

FIG. 2B illustrates an embodiment of an adaptive antenna system that uses multiple switches to electrically connect and electrically disconnect antenna elements.

FIG. 2C illustrates an embodiment of an adaptive antenna system that connects different antenna elements with an antenna feed.

FIG. 3 illustrates a block diagram of an embodiment of an adaptive antenna array system.

FIG. 4 illustrates a block diagram of an embodiment of a phase control component that may be incorporated as part of an adaptive antenna array.

FIG. 5 illustrates a block diagram of another embodiment of a phase control component that may be incorporated as part of an adaptive antenna array.

FIG. 6 illustrates a block diagram of an embodiment of an adaptive antenna array in which different antenna structures are used that are tuned for different harmonic frequencies.

FIG. 7 illustrates an embodiment of an adaptive antenna array system in which different antenna structures are tuned for different harmonic frequencies.

FIG. 8 illustrates exemplary test results of the adaptive antenna system of FIG. 2C.

FIG. 9 illustrates exemplary test results of the adaptive antenna system of FIG. 2B.

FIG. 10 illustrates additional exemplary test results of the adaptive antenna system of FIG. 2B.

FIG. 11 illustrates exemplary test results of an adaptive antenna system that uses a programmable capacitor array (PAC) to control impedance and phase.

FIG. 12 illustrates exemplary test results of the adaptive antenna system of FIG. 7.

FIG. 13 illustrates additional exemplary test results of the adaptive antenna system of FIG. 7.

FIG. 14 illustrates exemplary test results of the adaptive antenna array system of FIG. 3 at 2.405 GHz that uses the phase control component of FIG. 4.

FIG. 15 illustrates an embodiment of a method for selecting an operating mode of an adaptive antenna system.

### DETAILED DESCRIPTION

For certain types of devices, when designed and manufactured, little may be known about the operating environment that the device will be operated in. This may be especially true for devices that will be operating in a home. Home automation devices, Internet of Things (IoT) devices, or, more generally, any device that wirelessly communicates with another device, may be installed throughout a home with little or no regard to the orientation of the device's antenna or the effect of position or operating environment on wireless communication. This device may require a sufficient signal strength via its antenna to wirelessly communicate with various other devices within the home, such as other home automation devices, IoT devices, routers, and/or access points. An antenna, at a given frequency or frequency band, has a radiation pattern. This radiation pattern defines how effective the antenna is for receiving and transmitting radio waves in particular directions at the frequency or in the frequency band. While a particular antenna may be highly effective for transmitting or receiving in a first direction at the frequency, the antenna may be significantly less effective at the frequency in a second direction. This can lead to a decrease in data throughput, the use of a higher signal power (either by the device or the remote device transmitting radio waves to the device), and, in a worst-case scenario, the loss of the ability to communicate with a remote device located in the second direction with which wireless communication is being attempted.

Since it can be unknown how an antenna of a device will be oriented in relation to another device with which wireless communication is desired, it may be desirable for the radiation pattern of an antenna to be adjustable. An antenna may be required to transmit and receive data at a defined frequency or frequency band such as to comply with various wireless communication protocols (e.g., under IEEE's 802.11 and 802.15.4 standards, or Z-Wave®). While the frequency may not be adjustable, physical and/or electrical characteristics of the antenna may be adjusted to modify how the antenna behaves at the frequency. The antenna may have its radiation pattern adjusted and, thus, the antenna's efficiency in being able to transmit and receive radio waves in particular directions at the frequency may be improved.

The radiation pattern of an antenna can be adjusted in multiple ways, which may be implemented individually or in combination. First, the structure of the antenna may be adjusted by electrically connecting and disconnecting a portion of the antenna's radiating structure. The shape of the antenna may be adjusted, which affects the radiation pattern, by electrically connecting and disconnecting an electrically conductive material via one or more switches. The radiating structure of the antenna may be adjusted by connecting or disconnecting a portion of the radiating structure or by connecting an entirely different radiating structure with the antenna feed. Such connection and disconnection via a switch can change the type of antenna, such as from a dipole to a loop antenna type.

Second, if an array of antennas is being used, the relative phase delay between the antennas can be adjusted, which affects the radiation pattern (and, thus sensitivity) of the antenna array. By adjusting a length of transmission line between one of the antennas and the antenna array's feed, a phase difference between the antennas of the array and the antenna array feed point is introduced, thus altering the radiation pattern of the array. In other embodiments, different matching networks, such as those using an array of capacitors, can accomplish a similar goal as adjusting the length of transmission line.

Third, an antenna may be modified such that alternate radiating structures are used that are of the same antenna type but are tuned for different frequencies that are harmonic frequencies of the frequency at which the antenna will be used for transmission and/or reception. For instance, two antenna radiating structures may be present that are of a same type. The length of the first antenna radiating structure may be optimized for 2.4 GHz. The length of the second antenna radiating structure may be optimized for 800 MHz and, thus, its third harmonic frequency is 2.4 GHz. By using the second antenna radiating structure for 2.4 GHz, the radiation pattern of the antenna will vary significantly from the radiation pattern of the first antenna radiating structure that is operating at its first harmonic frequency. In other embodiments, this third variation may use antenna radiating structures of different types (e.g., a monopole and meandering monopole type antenna).

Since the operating environment of the device having the adaptive antenna system may be unknown, the adaptive antenna may be adjusted according to one or more of the above detailed modifications to test the antenna in various states periodically or in response to insufficient signal strength (e.g., the signal-to-noise ratio). While it may not be known which antenna state will be most effective for a given situation (e.g., since the location of the antenna and the device with which the antenna will be used to communicate with may be unknown), various available antenna states may be tested and the state associated with the highest signal strength (e.g., signal to noise ratio (SNR), received signal strength (RSSI), and throughput) may be used for communication for at least a period of time.

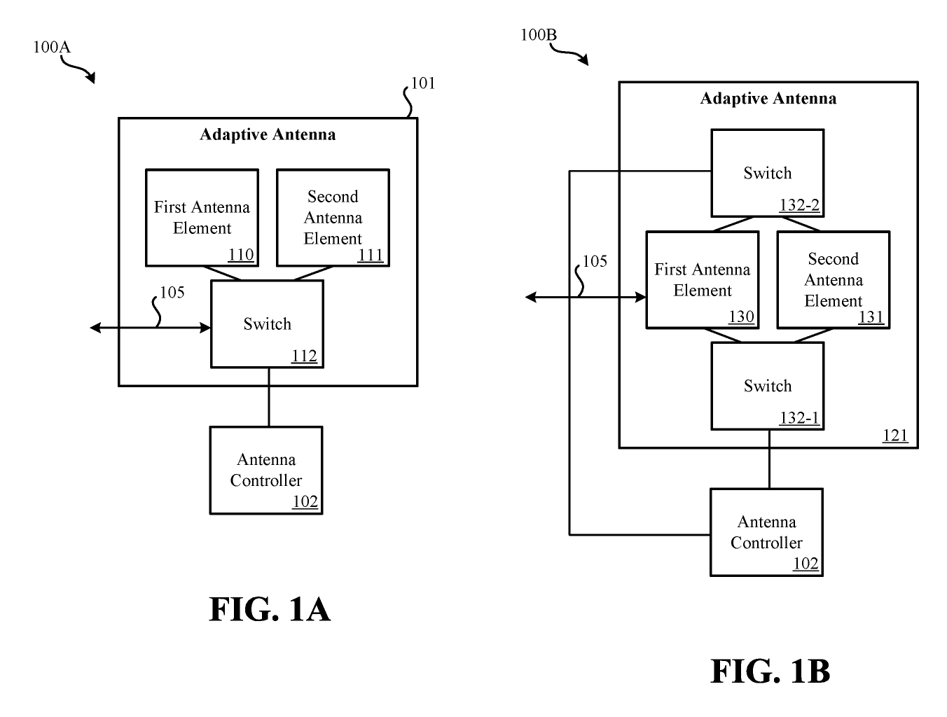

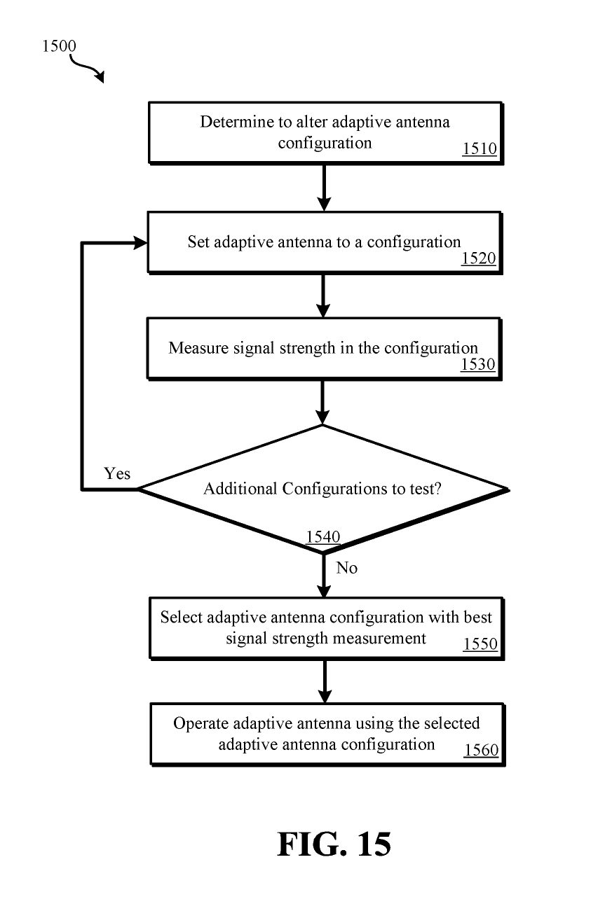

FIG. 1A illustrates an embodiment of an adaptive antenna system 100A. Adaptive antenna system 100A can include an adaptive antenna 101 and antenna controller 102. Adaptive antenna 101 may include: first radiating element 110, second radiating element 111, and switch 112. Antenna controller 102 may represent a controller, processor, or other form of integrated circuit that can control switch 112. The functionality of antenna controller 102 may be software that is executed by a general-purpose processor or coded into programmable firmware, such as an field programmable gate array. Special purpose hardware may also be used to perform the functionality of antenna controller 102. Antenna controller 102 may perform signal strength measurements of adaptive antenna 101 on received signals. Such measurements may be performed with the switch in different positions (e.g., a first state and a second state). The state that yields the highest signal strength may be the state in which antenna controller 102 sets switch 112 for a period of time. Further detail regarding how switch 112 is controlled by antenna controller 102 is provided in relation to method 1500 of FIG. 15.

Switch 112 may serve to electrically connect an antenna feed 105 to either first radiating element 110, second radiating element 111, or both. In other embodiments, switch 112 may serve to electrically connect and disconnect first radiating element 110 and second radiating element 111.

First radiating element 110 may be shaped and positioned relative to a ground plane (not illustrated) such that adaptive antenna 101 is a dipole antenna when switch 112 connects an antenna feed to first radiating element 110 and disconnects the antenna feed from second radiating element 111. Second radiating element 111 may be shaped and positioned relative to the ground plane such that adaptive antenna 101 is a loop antenna when switch 112 connects the antenna feed to the second radiating element 111 and disconnects the antenna feed from the first radiating element 110. While dipole and loop antennas are two types of antennas that may be formed by adaptive antenna, it should be understood that other types of antennas are also possible.

FIG. 1B illustrates an embodiment of an adaptive antenna system 100B. Adaptive antenna system 100B can include an adaptive antenna 121 and antenna controller 102. Adaptive antenna 121 may include: first antenna element 130, second antenna element 131, and switches 132. Antenna controller 102 may control switches 132. In adaptive antenna system 100B, multiple switches are present (132-1, 132-2). Switches 132 are used to electrically connect and disconnect first antenna element 130 and second antenna element 131 in multiple locations. In some embodiments, second antenna element 131 may be a ground plane. The type of antenna formed by first antenna element 130 and second antenna element 131 may be dependent on the states of switches 132. Antenna feed 105 may be fed to a fixed location on first antenna element 130. It should be understood, however, in other embodiments, one or more switches may be used to alter where antenna feed 105 connects first antenna element 130 or second antenna element 131.

In adaptive antenna system 100B, antenna controller 102 may control the states of both switches 132. If each of switches 132 has two states, then four possible configurations of adaptive antenna 121 may be possible. While adaptive antenna system 100B illustrates an adaptive antenna that has four possible states, it should be understood that other embodiments of adaptive antenna 121 may have fewer or a greater number of possible states. For example, it may be possible to have an additional switch that causes a third antenna element to be electrically connected or disconnected from first antenna element 130, thus changing the size and shape of the effective antenna element.

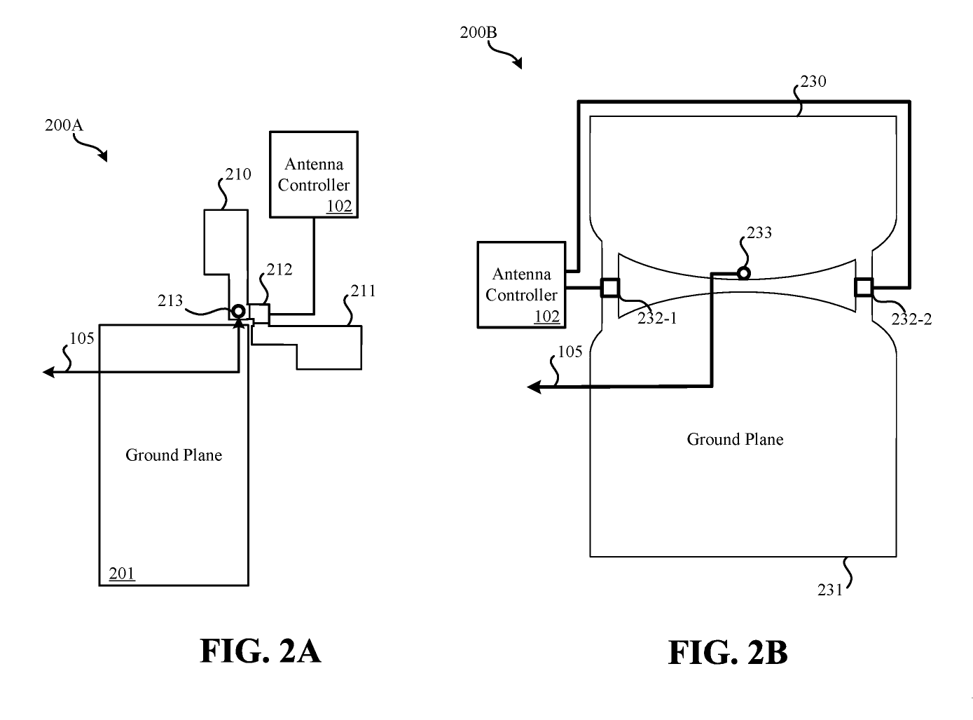

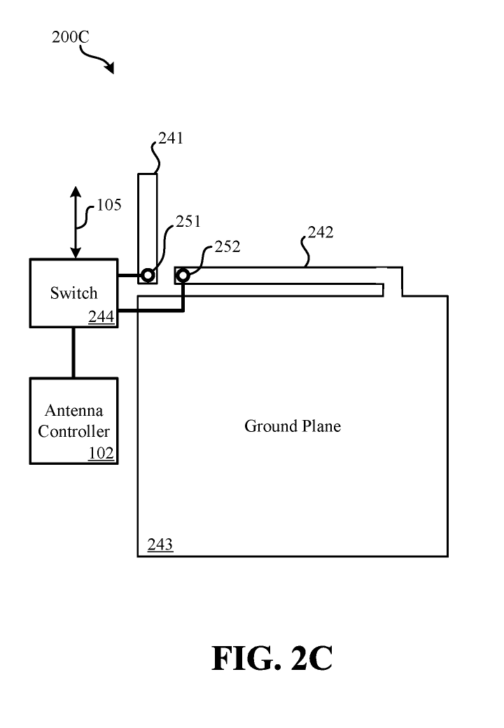

FIG. 2A illustrates an adaptive antenna system 200A. Adaptive antenna system 200A represents an embodiment of adaptive antenna system 100A of FIG. 1A. Antenna element 210, antenna element 211, and ground plane 201 may represent conductive material printed on a circuit board. In adaptive antenna system 200A, switch 212 electrically connects and electrically disconnects antenna element 210 and antenna element 211 based on an electrical signal output by antenna controller 102 (e.g., a high output from antenna controller 102 may electrically connect antenna elements 211 and 212 and a low output from antenna controller 102 may electrically disconnect antenna elements 211 and 212). Antenna feed 105 may remain electrically connected with antenna feed point 213 located at a fixed location on antenna element 210. Antenna elements 210 and 211 may be located in fixed locations relative to ground plane 201. Element 210 is a dipole antenna with a first polarization (e.g., vertical polarization), while element 211 is a dipole antenna with a second polarization (e.g., horizontal polarization). When both elements are electrically connected, the resulting dipole antenna can have a 45° polarization.

While changing radiation pattern can represent a way of improving wireless communication, adjusting polarization may also help improve wireless communication between wireless devices even if the radiation pattern is otherwise unchanged. For example, in particular environment that includes the physical arrangement of two wireless devices in relation to each other, different polarizations may affect the SNR, RSSI, or throughput. It should be understood that adjustment of polarization can also be performed in conjunction with adjusting radiation pattern (i.e. a different antenna arrangement may adjust both radiation pattern and polarization).

Adaptive antenna system 200A may exhibit a first radiation pattern at a frequency when antenna element 211 is electrically disconnected from antenna element 210 by switch 212. In this state, antenna element 211 may have a minimal effect on the radiation pattern of the adaptive antenna of adaptive antenna system 200A. The adaptive antenna of adaptive antenna system 200A may exhibit a second radiation pattern at the same frequency when antenna element 211 is electrically connected with antenna element 210 via switch 212. These different radiation patterns may be indicative of directions in which radio waves at a particular frequency emitted by adaptive antenna system 200A have a higher signal strength or lower signal strength relative to each other. Similarly, these different radiation patterns may be indicative of directions in which the adaptive antenna of adaptive antenna system 200A is more sensitive or less sensitive for receiving radio waves at the particular frequency. Therefore, for a particular direction at the particular frequency, adaptive antenna system 200A may function more effectively when antenna element 211 is electrically connected with antenna element 210; however, for another direction at the particular frequency, adaptive antenna system 200A may function more effectively when antenna element 211 is electrically disconnected from antenna element 210. Since antenna controller 102 may have little or no information about the direction in which a remote wireless device with which adaptive antenna system 200A is being used to communicate is located, the various antenna structures formed by connecting and disconnecting antenna element 210 and antenna element 211 may be tested to determine which configuration provides a better SNR, RSSI, or throughput (or some other metric that can be used to quantify strength/quality of a wireless signal) for transmission and/or reception.

FIG. 2B illustrates an adaptive antenna system 200B. Adaptive antenna system 200B represents an embodiment of adaptive antenna system 100B of FIG. 1B. In adaptive antenna system 200B, switches 232 electrically connect and electrically disconnect antenna element 230 and antenna element 231 (which is the ground plane) based on electrical signals output by antenna controller 102. Antenna feed 105 may remain electrically connected with a fixed location on antenna element 230. Antenna elements 230 and 231 may be located in fixed locations relative to each other, but the type of antenna collectively formed by antenna elements 230 and 231 may change based on the state of the switches 232. Antenna elements 230 and 231 may represent conductive material on a substrate, such as a printed circuit board. Antenna element 230 and 231 may approach, but not touch, each other near feed point 233 of antenna feed 105. From feed point 233, antenna elements 230 and 231 may curve away from each other as illustrated. Two conductive bridges on either side of the antenna feed point have switches that electrically connect and disconnect antenna element 230 and 231 based on input from antenna controller 102. Table 1 relates the type of antenna formed by adaptive antenna system 200B based on the state of switches 232 as controlled by antenna controller 102.

TABLE 1

| Antenna Type | State of Switch 232-1 | State of Switch 232-2 |
|---|---|---|
| Dipole | Disconnected | Disconnected |
| Right-facing Vivaldi | Connected | Disconnected |
| Left-facing Vivaldi | Disconnected | Connected |
| Slot Antenna | Connected | Connected |

Adaptive antenna system 200B may exhibit a first radiation pattern at a frequency when switches 232 are set to form a dipole antenna. Adaptive antenna system 200B may exhibit a second radiation pattern at the frequency when switches 232 are set to form a right-facing Vivaldi antenna. Adaptive antenna system 200B may exhibit a third radiation pattern at the frequency when switches 232 are set to form a left-facing Vivaldi antenna. Adaptive antenna system 200B may exhibit a fourth radiation pattern at the frequency when switches 232 are set to form a slot antenna.

Since four radiation patterns are possible, for a particular direction at the particular frequency, adaptive antenna system 200B may function most effectively in one of the four states. Since antenna controller 102 may have little or no information about the direction in which a remote wireless device that adaptive antenna system 200B is being used to communicate is located, the various antenna structures formed by connecting and disconnecting switches 232 may be tested to determine which configuration provides a better SNR, RSSI, or throughput (or some other metric for measuring strength/quality of a wireless signal) for transmission and/or reception.

FIG. 2B provides an example of how two switches can be used to form four antenna types using two antenna elements. It should be understood that the antenna element structures and placement of switches 232 are merely exemplary; in other embodiments, a greater number of switches (or switches with more than two states) may be used and/or differently shaped antenna elements may be used such that electrical connection and disconnection using the switches allows the adaptive antenna system to form different antenna types.

FIG. 2C illustrates an adaptive antenna system 200C. Adaptive antenna system 200C represents an embodiment of adaptive antenna system 100A of FIG. 1A; while adaptive antenna system 200A represents an embodiment in which a switch electrically connects and disconnects antenna elements from each other, adaptive antenna system 200C represents an embodiment in which the antenna feed is switched between being connected with a first antenna element and a second antenna element. In adaptive antenna system 200C, switch 212 electrically connects and electrically disconnects antenna feed 105 from antenna element 210 and antenna element 211 based on an electrical signal output by antenna controller 102. As such, only antenna element 241 or antenna element 242 may be connected with antenna feed 105 via switch 244 at a given time. Each of antenna elements 241 and 242 have distinct antenna feed points.

Antenna element 241, antenna element 242, and ground plane 243 may represent conductive material printed on a circuit board. Antenna element 241 is shaped and positioned relative to ground plane 243 such that, when switch 244 is electrically connecting antenna feed 105 with antenna feed point 251, a dipole antenna is formed by adaptive antenna system 200C. Antenna element 221 is shaped and positioned relative to ground plane 243 such that when switch 244 is electrically connecting antenna feed 105 with antenna feed point 252, a loop antenna is formed by adaptive antenna system 200C. For such a loop antenna, antenna element 242 has an end distal from antenna feed point 252 electrically connected with ground plane 243. Ground plane 243 may be at least partially made up of a metallic structure that is part of a chassis of a device in which the antenna is incorporated.

Adaptive antenna system 200C may exhibit a first radiation pattern at a frequency when antenna element 241 is electrically connected with antenna feed 105. In this state, antenna element 242 may have a minimal effect on the radiation pattern of the adaptive antenna of adaptive antenna system 200C. The adaptive antenna of adaptive antenna system 200C may exhibit a second radiation pattern at the same frequency when antenna element 242 is electrically connected with antenna feed 105. These different radiation patterns may be indicative of directions in which radio waves at a particular frequency emitted by adaptive antenna system 200C have a higher signal strength or lower signal strength relative to each other. Similarly, these different radiation patterns may be indicative of directions in which the adaptive antenna of adaptive antenna system 200C is more sensitive or less sensitive for receiving radio waves at the particular frequency. Therefore, for a particular direction at the particular frequency, adaptive antenna system 200C may function more effectively when functioning as a dipole antenna, but may function more effectively as a loop antenna for a different direction at the same frequency. Since antenna controller 102 may have little or no information about the direction in which a remote wireless device with which adaptive antenna system 200C is being used to communicate is located, the various antenna structures formed by connecting and disconnecting antenna elements 241 and 242 with antenna feed 105 may be tested to determine which configuration provides a better SNR for transmission and/or reception.

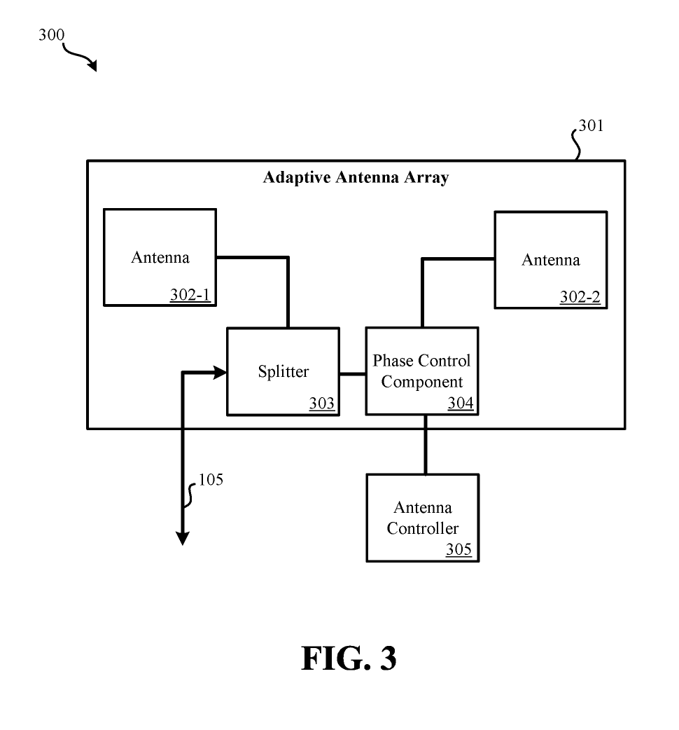

FIG. 3 illustrates an embodiment of an adaptive antenna array system 300. Adaptive antenna array system 300 may include antenna controller 305, and adaptive antenna array 301. Adaptive antenna array 301 may include antennas 302, splitter 303, and phase control component 304. Antenna feed 105 may be connected with splitter 303 which connects antenna feed 105 with antenna 302-1 and antenna 302-2. Splitter 303 may be connected with antenna 302-1 via a length of transmission line having an impedance. Splitter 303 may be connected with antenna 302-2 also via a transmission line and, additionally, phase control component 304. Phase control component 304 may be controlled by antenna controller 305. Phase control component 304 may allow a phase of the signal transmitted or received between splitter 303 and antenna 302-2 to be adjusted.

Antenna 302-1 and antenna 302-2 may represent distinct instances of a same type of antenna. For example, antenna 302-1 and antenna 302-2 may both be dipole antennas that are located a distance from each other. The radiation pattern of antennas 302 may be affected by a physical distance between antennas 302 and any phase difference occurring between splitter 303, antenna 302-1, and antenna 302-2. Since antenna 302-1 and antenna 302-2 are located in fixed positions, the radiation pattern of adaptive antenna array 301 may be modified by adjusting the phase between one or both of antennas 302 and splitter 303. In the illustrated embodiment, a single phase control component, phase control component 304, is located between splitter 303 and antenna 302-2. As such, the relative phase between splitter 303 and antenna 302-2 may be modified as compared to the transmitted signal between splitter 303 and antenna 302-1.

By a relative phase being induced on a signal either received or transmitted between splitter 303 and antenna 302-2 as compared to between splitter 303 and antenna 302-1, the radiation pattern of adaptive antenna array 301 can be adjusted. By the radiation pattern of adaptive antenna array 301 being adjusted, adaptive antenna array 301 can be tuned to more effectively receive and transmit radio waves at a particular frequency in different directions.

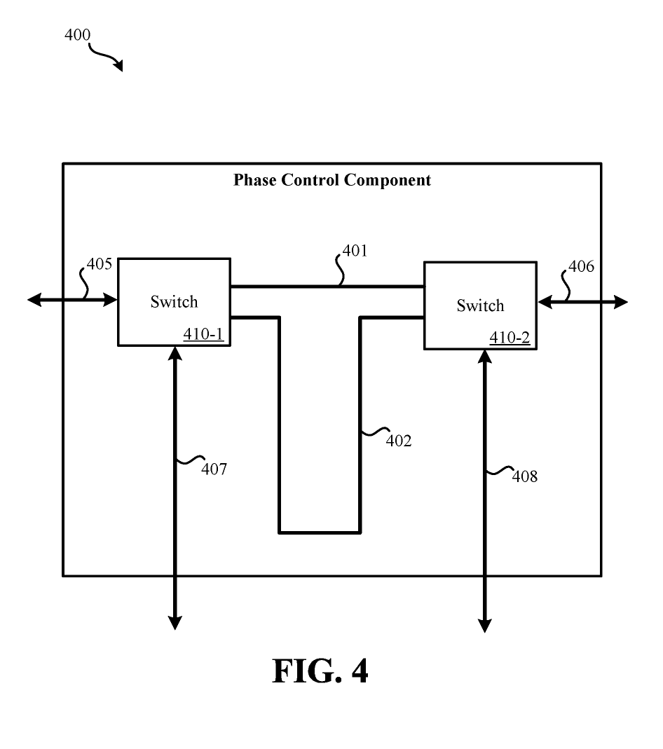

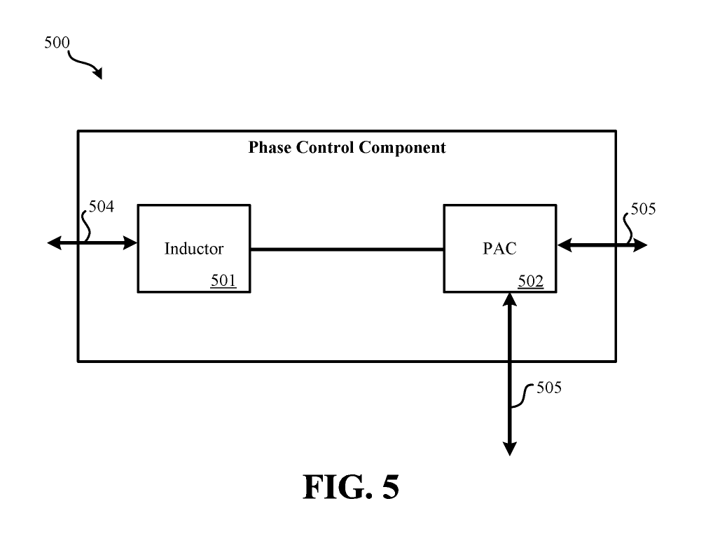

In the illustrated embodiment of FIG. 3, antenna controller 305 may be used to control phase via communication with phase control component 304. Various ways in which antenna controller 305 and phase control component 304 can control phase are detailed in relation to FIGS. 4 and 5. Antenna controller 305 may function similarly to the previously detailed antenna controllers. That is, antenna controller 305 may have little or no information about how adaptive antenna array 301 is physically positioned or oriented in relation to the remote wireless device with which adaptive antenna array 301 is being used to communicate. Antenna controller 305 may alter a phase induced by phase control component 304 between splitter 303 and antenna 302-2 in order to observe changes in SNR for received signals of a particular frequency. Based upon comparing the observed SNRs, antenna controller 305 may set phase control component 304 to a particular phase.

While adaptive antenna array 301 is illustrated as having two antennas, it should be understood that, in other embodiments, a greater number of antennas may be incorporated as part of the adaptive antenna array. The radiation pattern of adaptive antenna array 301 may be affected by the number of antennas, the distance separating the antennas, the types of antennas, and the phase difference between the various antennas and antenna feed 105. Therefore, for example, an alternate embodiment of adaptive antenna array 301 may include three antennas in which phase is adjusted by antenna controller 305 along one, two, or all three of the transmission lines between the antenna feed and the antennas.

FIG. 4 illustrates a block diagram of an embodiment of phase control component 400 that may be incorporated as part of an adaptive antenna array. Phase control component 400 may be incorporated in adaptive antenna array 301 as phase control component 304. Phase control component 400 may include switches 410, transmission line 401, and transmission line 402. Switches 410 may alternatively connect: transmission line 401 with signal feeds 405 and 406 or transmission line 402 with the signal feeds 405 and 406. Signal feed 405 may be connected with splitter 303, which connects with antenna feed 105. Signal feed 406 may be connected with antenna 302-2.

Transmission lines 401 and 402 may represent traces of varying lengths printed on a circuit board. Since transmission line 401 is shorter than transmission line 402, depending on whether transmission line 401 or transmission line 402 is connected with signal feeds 405 and 406, an amount of phase induced between splitter 303 and antenna 302-2 may be adjusted (as compared to the signal between splitter 303 and antenna 302-1).

Control lines 407 and 408 may control the state of switches 410. Control lines 407 and 408 may originate from antenna controller 305. As an example, when switches 410 electrically connect transmission line 401 with signal feed 405 and 406 and, thus, disconnect transmission line 402 from signal feeds 405 and 406, no phase difference between splitter 303 and antennas 302 may be present. When switches 410 electrically connect transmission line 402 with signal feed 405 and 406 and, thus, disconnect transmission line 401 from signal feeds 405 and 406, a phase difference between splitter 303 and antenna 302-2 (as compared to between splitter 303 and antenna 302-1) may be present. The amount of phase difference may be based on the length of transmission line 402. For example, at a particular frequency, a quarter wave phase delay may be introduced by transmission line 402. The radiation pattern of the adaptive antenna array is altered at a given frequency due to this phase delay being introduced.

In the illustrated embodiment of phase control component 400, switches 410 alternate between two different lengths of transmission line that control an amount of phase delay introduced between a splitter and antenna. It should be understood that in other embodiments, three or more different lengths of transmission line may be used to introduce varying amounts of phase delay between a splitter and an antenna as compared to another antenna that is part of the array. The greater number of lengths of transmission line present between switches 410 may allow for finer tuning of a radiation pattern of the adaptive antenna array. Further, phase control components may be present on multiple transmission lines between an antenna feed source and antennas. These phase control components may be used in conjunction with each other to adjust a phase difference between three or more antennas.

FIG. 5 illustrates a block diagram of an embodiment of a phase control component 500 that may be incorporated as part of an adaptive antenna array. Phase control component 500 may be incorporated in adaptive antenna array 301 as phase control component 304. Phase control component 500 may include inductor 501 and programmable array of capacitors (PAC) 502. Signal feed 504 may connect with splitter 303 and signal feed 505 may connect with antenna 302-2. By using an inductor and a PAC in series, the relative phase between two antennas, such as antennas 302-1 and 302-2, may be altered. By altering the relative phase, adaptive antenna array 301 may effectively be used as a scanning array that has increased sensitivity in one or more particular directions that can be adjusted. The amount of capacitance of PAC 502 may be adjusted based on input provided by an antenna controller via control line 503. By the capacitance of PAC 502 being increased or decreased, a relative amount of phase delay may be introduced. PAC 502 may allow for many different capacitance values to be set, thus allowing for a high degree of adjustment of a phase difference between the two antennas.

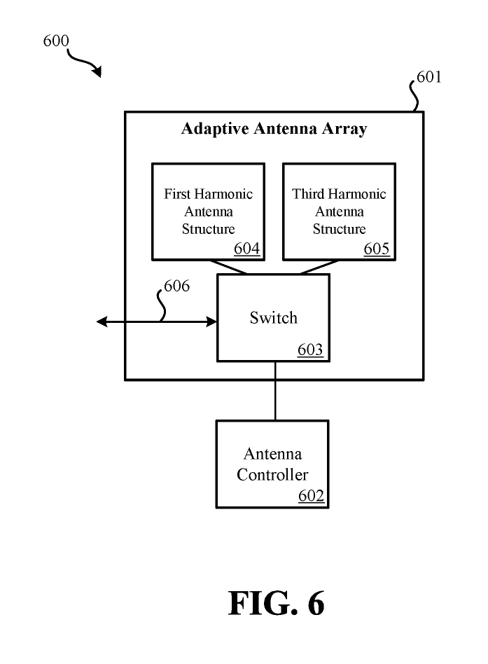

FIG. 6 illustrates a block diagram of an embodiment of an adaptive antenna array system 600 in which different antenna structures are used that are tuned for different harmonic frequencies. An antenna may be most effective for transmission and reception at its first harmonic frequency. As compared to non-harmonic frequencies, such an antenna will function more effectively at other harmonic frequencies. For example, an antenna that is sized to receive and transmit at a given frequency may also be effective for transmitting and receiving wireless signals at a second, third, and higher harmonic of the given frequency as compared to non-harmonic frequencies. When operated at a second or higher harmonic frequency, the antenna may have a significantly different radiation pattern as compared to the antenna when operated at the first harmonic frequency.

Adaptive antenna array system 600 may include adaptive antenna array 601 and antenna controller 602. Adaptive antenna array 601 may include first harmonic antenna structure 604, third harmonic antenna structure 605, and switch 603. Switch 603 may control whether antenna feed 606 is connected with first harmonic antenna structure 604 or third harmonic antenna structure 605. First harmonic antenna structure 604 and third harmonic antenna structure 605, when active, may represent the same or different antenna types. For example, both antenna structures may, in conjunction with a ground plane, be dipole antennas. One or both of the antenna structures may use meandering arms, such as to save space.

If adaptive antenna array 601 is to be used at a particular frequency, such as 2.4 GHz, first harmonic antenna structure 604 may be of a length selected such that the first harmonic operating frequency of first harmonic antenna structure 604 is at least approximately 2.4 GHz. Third harmonic antenna structure 605 may be of a length selected such that the third harmonic operating frequency is also at least approximately 2.4 GHz. Accordingly, the first harmonic frequency for the third harmonic antenna structure 605 may be around 800 MHz, thus resulting in third harmonic antenna structure 605 being physically longer than first harmonic antenna structure 604. When operated at 2.4 GHz, the radiation pattern of third harmonic antenna structure 605 will vary significantly from the radiation structure at 2.4 GHz of first harmonic antenna structure 604.

Based on input from antenna controller 602, switch 603 may connect either first harmonic antenna structure 604 or third harmonic antenna structure 605 with antenna feed 606 for transmitting or receiving wireless signals. While adaptive antenna array 601 illustrates only two antenna structures, it should be understood that additional antenna structures may be introduced in order to operate at other harmonic frequencies. For instance a third antenna structure may be introduced to operate at the second or fourth harmonic of the frequency of a wireless signal to be transmitted and/or received.

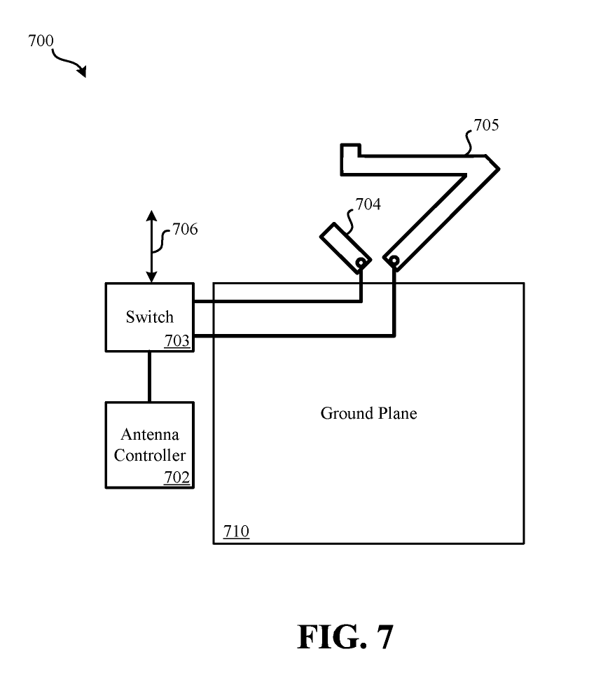

FIG. 7 illustrates an embodiment of an adaptive antenna array system 700 in which different antenna structures are used that are tuned for different harmonic frequencies. Adaptive antenna array system 700 can represent an embodiment of adaptive antenna array system 600 of FIG. 6. In adaptive antenna array system 700, antenna element 704 and antenna element 705 are alternatively connected with antenna feed 706 via switch 703. Antenna controller 702 controls which of antenna elements 704 and 705 are connected with antenna feed 706. Antenna element 704, in combination with ground plane 710, may form a dipole antenna. Antenna element 705, in combination with ground plane 710, may also form a dipole antenna having a meandering arm. While antenna element 704 has a length selected to operate at a first harmonic frequency, antenna element 705 has a length to operate at the third harmonic of the same frequency of antenna element 704. Thus, the radiation pattern of the adaptive antenna when antenna element 705 is in use may vary significantly from the radiation pattern of the adaptive antenna when antenna element 704 is in use. In some embodiments, adaptive antenna array system 700 is designed to operate at 2.4 GHz. As such, the length of antenna element 704 is selected such that 2.4 GHz is the first harmonic frequency and 800 MHz is the first harmonic frequency of antenna element 705 (and, thus, 2.4 GHz is the third harmonic frequency).

While FIG. 7 uses two antenna elements, it should be understood that other embodiments may use more antenna elements that operate at other harmonic frequencies, such as the second, fourth, fifth, etc. It should also be understood that the embodiments of FIGS. 1A-7 can be combined to form hybrid adaptive antenna system arrays. For example, the adaptive antenna array systems of FIG. 1A and FIG. 7 can be combined such that a portion of an antenna element of adaptive antenna array system 700 can be connected and disconnected as is performed in accordance with FIG. 1A. As another example, an array of antennas as in FIGS. 2B and 2C may be used with the relative phase to the antennas being adjusted using an adaptive antenna array as in FIG. 3.

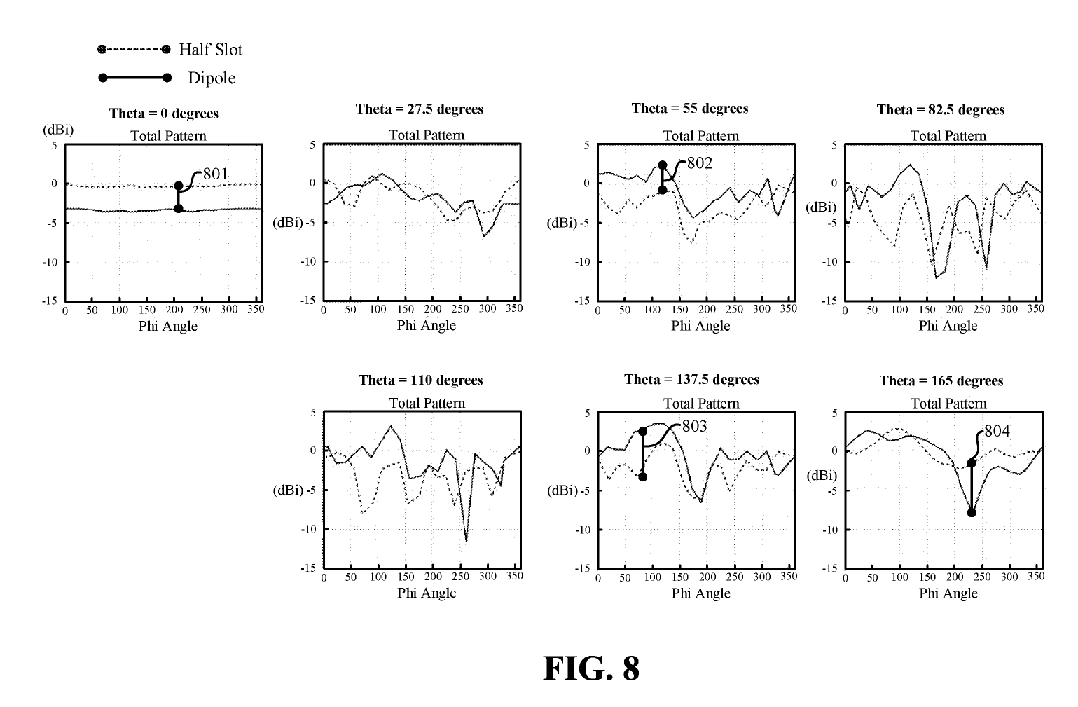

The following graphs illustrate radiation patterns for various embodiments of adaptive antenna systems. These radiation patterns are valid for both transmission and reception because the receiving pattern of an antenna is identical to the far-field radiation pattern of the antenna when used for transmitting. FIG. 8 illustrates exemplary test results of adaptive antenna system 200C of FIG. 2C at 2.4 GHz. On each graph, the unit on the y-axis is gain in dBi. The dotted line represents the radiation pattern when antenna element 242 is connected with antenna feed 105 via switch 244 and the solid line represents the radiation pattern of the adaptive antenna when the dipole antenna element 241 is connected with the antenna feed via switch 244. As can be seen in the radiation pattern graphs, at certain angles, the loop antenna is more sensitive while at other angles the dipole antenna arrangement is more sensitive. As examples of the differences in sensitivity, the following specific values are noted: difference 801 illustrates a 3.5 dBi difference between the loop antenna and dipole antenna arrangement at a Theta of 0° and Phi angle of 205°; difference 802 illustrates a 3 dBi difference between the loop antenna and dipole antenna arrangement at a Theta of 55° and Phi angle of 120°; difference 803 illustrates a 6 dBi difference between the loop antenna and dipole antenna arrangement at a Theta of 137.5° and Phi angle of 75°; and difference 804 illustrates a 7 dBi difference between the loop antenna and dipole antenna arrangement at a Theta of 165° and Phi angle of 235°.

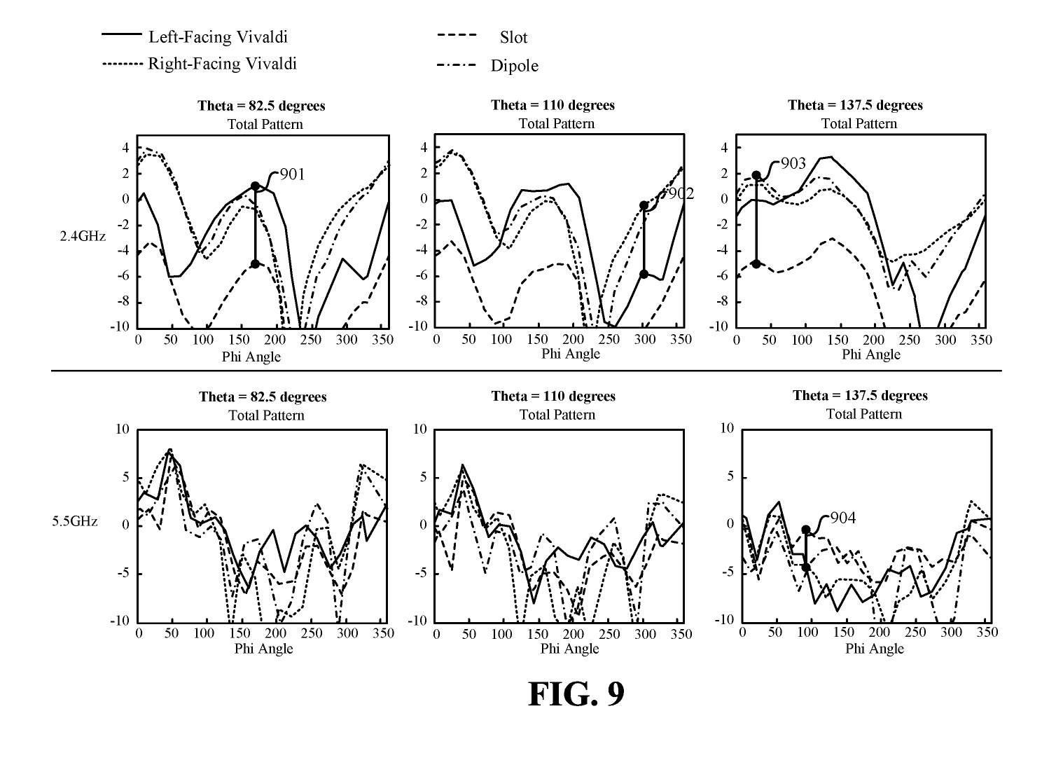

FIG. 9 illustrates exemplary test results of adaptive antenna system 200B of FIG. 2B. On each graph, the unit on the y-axis is gain in dBi. The antenna arrangements indicated are created by controlling switches 232 in accordance with Table 1. As can be seen in the radiation pattern graphs, at certain angles, each of the four adaptive antenna arrangements is more sensitive than the other arrangements. As examples of the differences in sensitivity, the following specific values are noted: difference 901 illustrates a 6 dBi difference between the left-facing Vivaldi and the slot antenna arrangement at a Theta of 82.5° and Phi angle of 170°; difference 902 illustrates a 5.5 dBi difference between the right-facing Vivaldi and the left-facing Vivaldi antenna arrangement at a Theta of 110° and Phi angle of 305°; difference 903 illustrates a 6.5 dBi difference between the dipole antenna arrangement and the slot antenna arrangement at a Theta of 137.5° and Phi angle of 30°; and difference 904 illustrates a 3.5 dBi difference between the loop antenna and each of the other three antenna arrangements at a Theta of 137.5° and Phi angle of 90°.

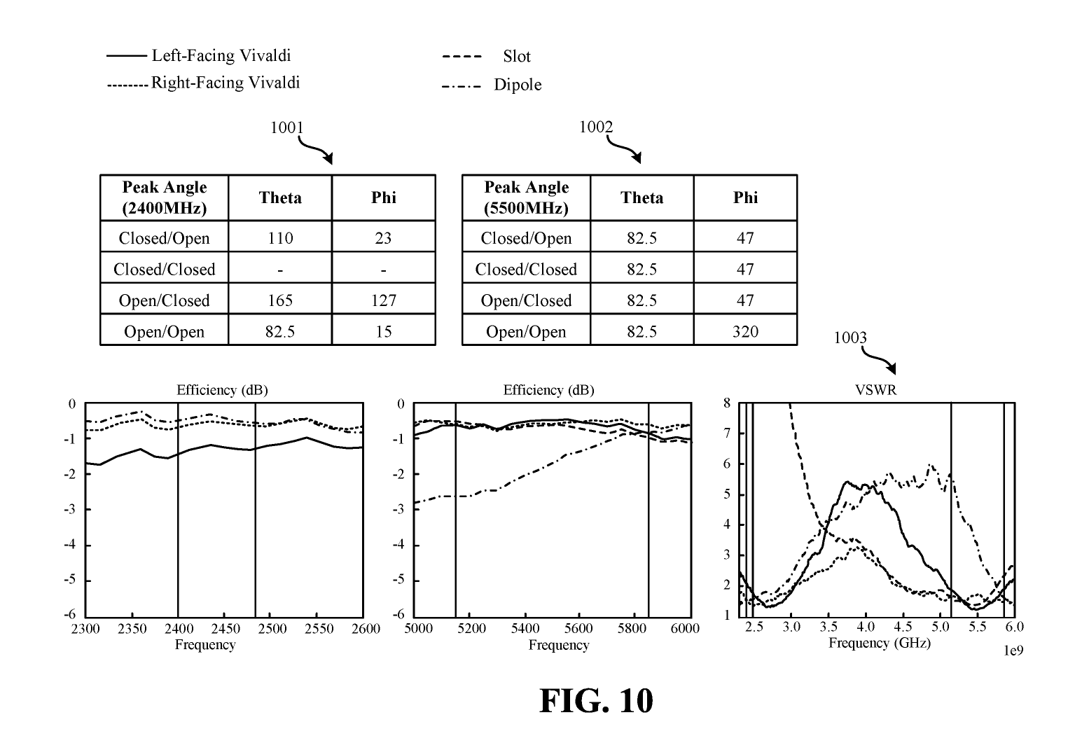

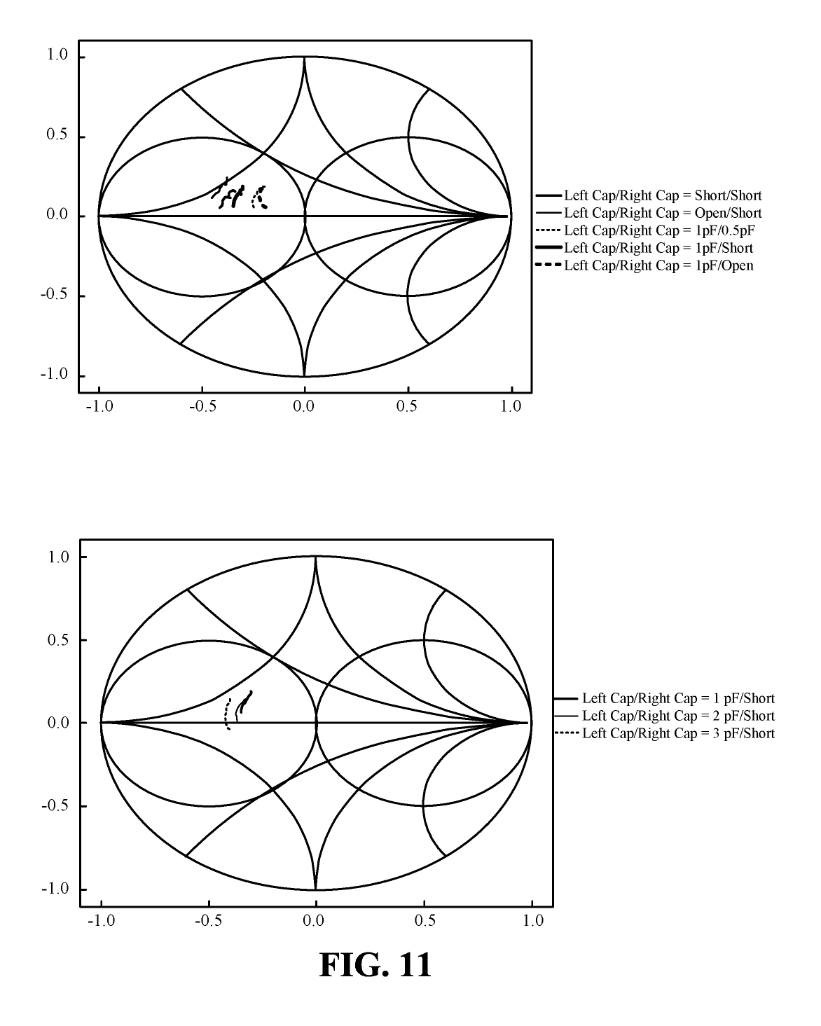

FIG. 10 illustrates additional exemplary test results of adaptive antenna system 200B of FIG. 2B. Tables 1001 and 1002 list the peak sensitivity angles at 2.4 GHz and 5.5 GHz, respectively. Graph 1003 shows the voltage standing wave ratio (VSWR) which is an indication of how well an antenna is matched to a transmission line, with a value of 1 being ideal and indicative of no power being reflected by the antenna.

FIG. 11 illustrates exemplary test results of an adaptive antenna system that uses a programmable capacitor array (PAC) to control impedance and phase. FIG. 11 can be based on an arrange similar to adaptive antenna array 301 of FIG. 3. In the embodiment of the adaptive antenna array used to produce the results of FIG. 11, a phase control component may be present between each of antennas 302 and splitter 303 (rather than the single phase control component 304 of the embodiment of FIG. 3). The Smith charts of FIG. 11 show the effect of placing capacitors of different values on the transmission lines between the splitter and antennas of FIG. 3. A short being present refers to no capacitor being present; an open circuit being present refers to an electrical connection between the antenna and the splitter not being present. Other values refer to the capacitance of the respective capacitor in picofarads. As can be seen from the Smith Charts, the load admittance of each variation of the adaptive antenna array varies based on the capacitance. As such, the antenna radiation pattern also varies based on such variations.

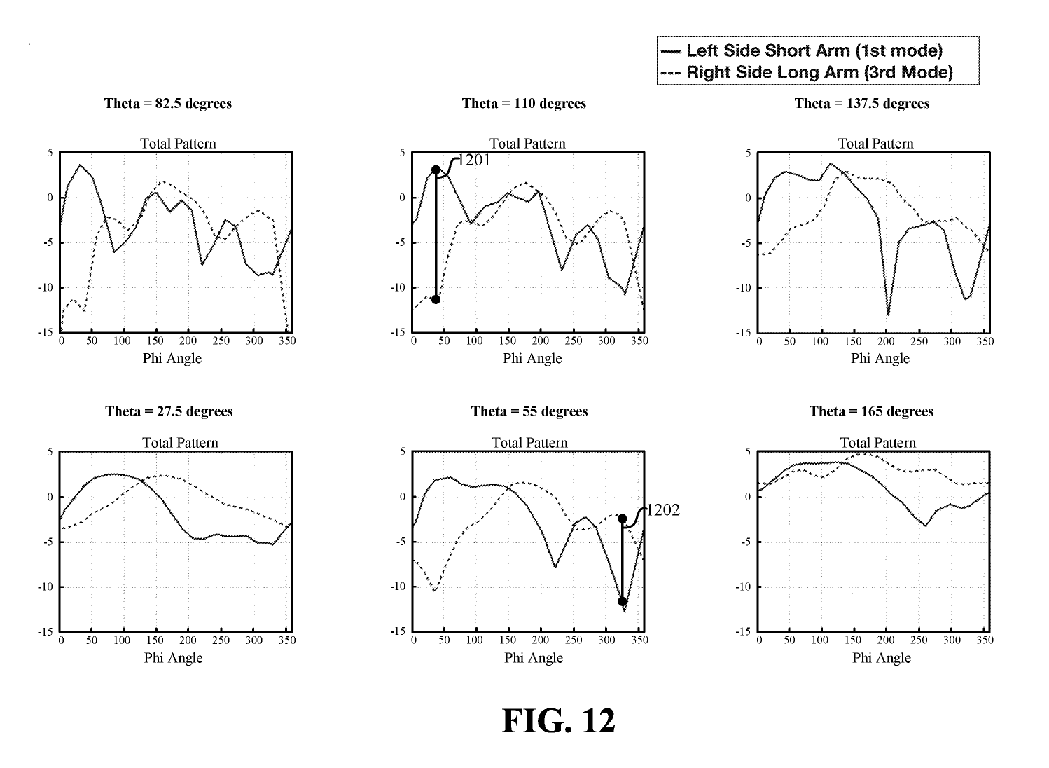

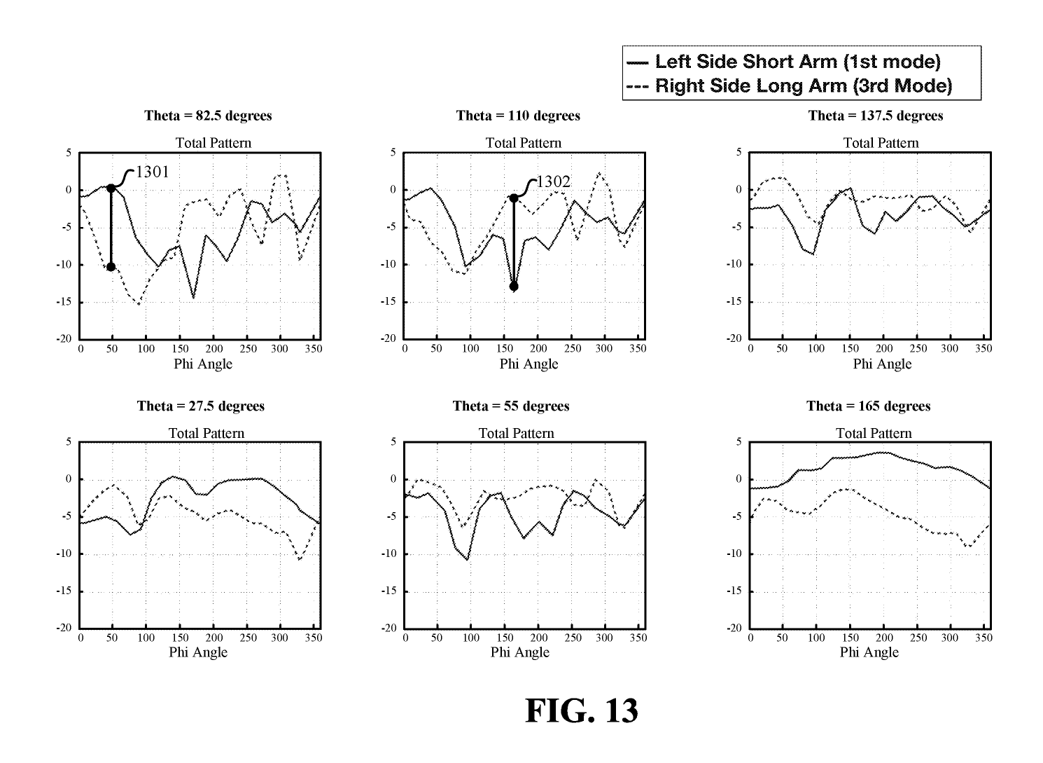

FIG. 12 illustrates exemplary test results of adaptive antenna array system 700 of FIG. 7 at 2.4 GHz. On each graph, the unit on the y-axis is gain in dBi. The antenna arrangements indicated are created by controlling switch 703 and alternatively connecting antenna feed 706 with antenna element 704 or 705. As can be seen in the radiation pattern graphs, at different Theta and Phi angles, each of the antenna arrangements is more sensitive than the other. As examples of the differences in sensitivity, the following specific values are noted: difference 1201 illustrates a 14 dBi difference between the short arm (1^{st} mode) and long arm (3^{rd} mode) at a Theta of 110° and Phi angle of 40°; and difference 1202 illustrates a 9 dBi difference between the long arm and the short arm antenna arrangements at a Theta of 55° and Phi angle of 325°. FIG. 13 illustrates exemplary test results of adaptive antenna array system 700 of FIG. 7 at 5.5 GHz. As examples of the differences in sensitivity, the following specific values are noted: difference 1301 illustrates a 11 dBi difference between the short arm (1^{st} mode) and long arm (3^{rd} mode) at a Theta of 82.5° and Phi angle of 50°; and difference 1302 illustrates a 12 dBi difference between the long arm and the short arm antenna arrangements at a Theta of 110° and Phi angle of 160°.

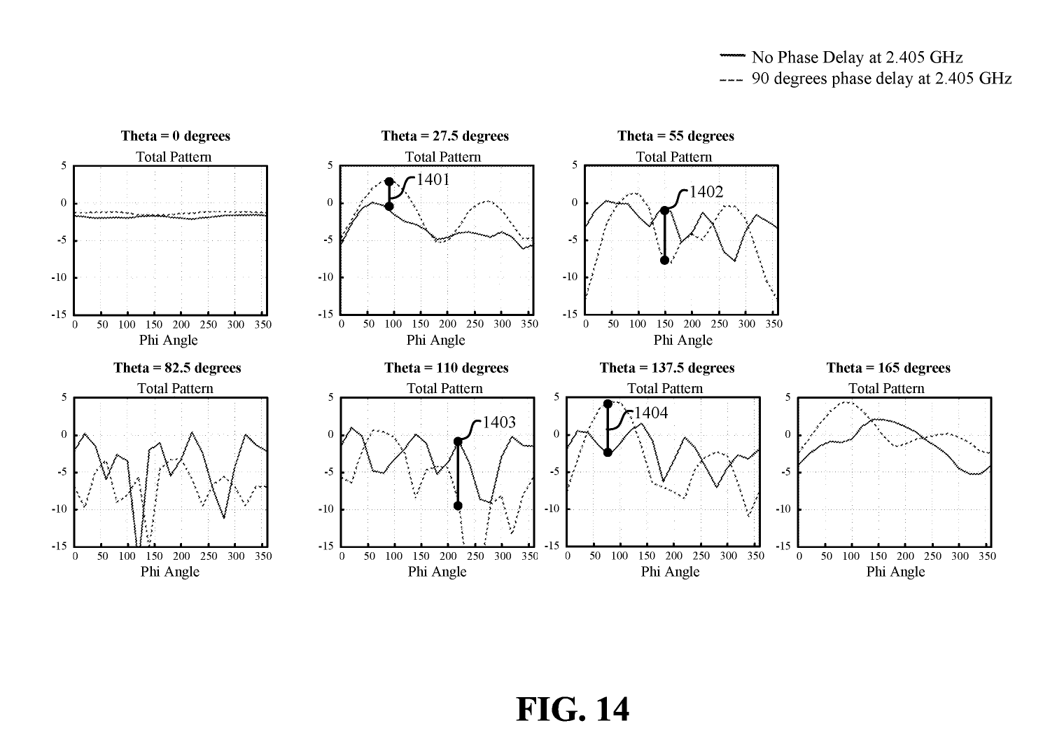

FIG. 14 illustrates exemplary test results of adaptive antenna array system 300 of FIG. 3 at 2.405 GHz that uses phase control component 400 of FIG. 4. On each graph, the unit on the y-axis is gain in dBi. A phase delay, relative to transmission to antenna 302-1, of approximately 90° is introduced at 2.5 GHz and approximately 200° at 5 GHz when transmission line 402 is active (whereas a phase delay of zero° may be present when transmission line 401 is active). An antenna controller controls the phase control component, which adjusts the length of the transmission line as illustrated in FIG. 4. In FIG. 4, the frequency is 2.405 GHz, thus the phase delay is approximately 90°. As examples of the differences in sensitivity, the following specific values are noted: difference 1401 illustrates a 4 dBi difference between no relative phase difference and a relative phase difference of approximately 90° at a Theta of 27.5° and Phi angle of 90°; difference 1402 illustrates a 7 dBi difference between no relative phase difference and a relative phase difference of approximately 90° at a Theta of 55° and Phi angle of 155°; difference 1403 illustrates a 8 dBi difference between no relative phase difference and a relative phase difference of approximately 90° at a Theta of 110° and Phi angle of 220°; and difference 1404 illustrates a 7 dBi difference between no relative phase difference and a relative phase difference of approximately 90° at a Theta of 137.5° and Phi angle of 80°.

It should be understood that the measurements of FIGS. 8-14 are merely exemplary and the values obtained may be modified by altering characteristics of the antenna structures and/or operating the antenna structures at an alternate frequency.

The adaptive antenna systems of FIGS. 1A-7 may be used in conjunction with various methods. FIG. 15 illustrates an embodiment of a method 1500 for selecting an operating mode of an adaptive antenna system. Blocks of method 1500 may be performed by any of the previously detailed antenna controllers, such as antenna controller 102, 602, or 702. The antenna controller may be specialized hardware (e.g., a dedicated integrated circuit), firmware being executed by a programmable gate array, or software executed by one or more general purpose processors. The processor that performs the functions of the antenna controller may also perform other processing functions.

At block 1510, the antenna controller may determine that the adaptive antenna configuration is to be altered. The determination of block 1510 can be based on a period of time elapsing, receiving an indication of the data throughput via the adaptive antenna dropping below a defined threshold for a period of time, receiving an indication that a connection with a remote device has been lost, receiving an indication that a new remote wireless device is being communicated with, detecting that the system that includes the adaptive antenna and antenna controller has been moved or reoriented, or receiving user input or input from another system or another component indicating that the adaptive antenna configuration is to be altered.

At block 1520, the antenna controller may provide one or more signals to one or more switches and/or phase delay components (depending on the type of adaptive antenna system) to cause the adaptive antenna to enter a first configuration or arrangement. At block 1530, a signal strength of a received signal may be measured. Additionally or alternatively, a signal may be transmitted via the adaptive antenna in the configuration of block 1520 and a signal strength measurement may be made and transmitted by the remote device that received the transmitted signal to the antenna controller. This received signal strength measurement may then be analyzed by the antenna controller or another component.

At block 1540, a determination is made if another antenna configuration is available that has not yet been tested since method 1500 began being performed. If so, method 1500 may proceed to block 1520 and continue testing additional adaptive antenna configurations until all combinations are exhausted. If all configurations of the adaptive antenna have been tested, method 1500 may proceed to block 1550. In some embodiments, if a signal strength over a particular threshold is observed, regardless of if any additional configurations being available to test, method 1500 may proceed to block 1550 from block 1540.

At block 1550, the adaptive antenna configuration that has the highest signal strength may be selected based on the measured results of block 1530. At block 1560, the adaptive antenna may be operated for at least a period of time according to the adaptive antenna configuration selected at block 1550. The adaptive antenna configuration selected at block 1560 may be used until one or more conditions that triggers block 1510 are present. In some embodiments, a particular adaptive antenna configuration may be stored and used for communicating with a particular remote wireless device. That is, based on the locations of various wireless devices, the antenna controller may use an adaptive antenna configuration that has been found to yield the highest signal strength for communication with that particular wireless device.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. An adaptive antenna system, comprising:
an adaptive antenna comprising:
a first radiating element;
a second radiating element;
a switch that electrically connects and disconnects the first radiating element and the second radiating element, wherein a type of antenna of the adaptive antenna varies based on whether the first radiating element is electrically connected with the second radiating element; and
an antenna controller that controls actuation of the switch, wherein a radiation pattern of the adaptive antenna varies at a particular frequency based on the first radiating element and the second radiating element being electrically connected or disconnected via the switch.

2. The adaptive antenna system of claim 1, wherein the type of the adaptive antenna is a slot antenna when the switch electrically connects the first radiating element with the second radiating element and the adaptive antenna is a dipole antenna when the switch electrically disconnects the first radiating element from the second radiating element.

3. The adaptive antenna of claim 1, further comprising:
a second switch that electrically connects and disconnects the first radiating element and the second radiating element, wherein:
the switch is a first switch; and
the type of antenna of the adaptive antenna varies based on whether the first radiating element is electrically connected with the second radiating element using the first switch, the second switch, both, or neither.

4. The adaptive antenna system of claim 3, wherein:
the type of the adaptive antenna is a slot antenna when the first switch and the second switch electrically connect the first radiating element with the second radiating element;
the type of the adaptive antenna is a dipole antenna when the first switch and the second switch electrically disconnect the first radiating element from the second radiating element;
the type of the adaptive antenna is a right facing Vivaldi antenna when the first switch electrically connects the first radiating element with the second radiating element but the second switch electrically disconnects the first radiating element from the second radiating element; and
the type of the adaptive antenna is a left facing Vivaldi antenna when the second switch electrically connects the first radiating element with the second radiating element but the first switch electrically disconnects the first radiating element from the second radiating element.

5. The adaptive antenna system of claim 1, wherein the type of the adaptive antenna is a dipole antenna when the switch electrically connects the first radiating element with the second radiating element and the adaptive antenna is a loop antenna when the switch electrically disconnects the first radiating element from the second radiating element.

6. The adaptive antenna system of claim 1, wherein the antenna controller is configured to: determine a first signal strength when the first radiating element is electrically connected with the second radiating element via the switch; determine a second signal strength when the second radiating element is electrically disconnected from the first radiating element via the switch; compare the first signal strength and the second signal strength to determine the first signal strength is greater; and cause, for at least a period of time, the switch to connect the first radiating element and the second radiating element based on determining the first signal strength is greater.

7. The adaptive antenna system of claim 1 wherein the first antenna element has a different polarization than the second antenna element.

8. An adaptive antenna array, comprising:
a first antenna;
a second antenna;
a first electrical connection from the first antenna to a transceiver;
a second electrical connection apparatus that connects the second antenna to the transceiver, wherein the second electrical connection apparatus comprises a phase control component; and
an antenna controller that controls a phase of an electrical signal via the phase control component, wherein a radiation pattern of the adaptive antenna array varies at a particular frequency based on a state of the phase control component.

9. The adaptive antenna array of claim 8, wherein the phase control component comprises a first switch, a second switch, a first transmission line, and a second transmission line, wherein the first switch and the second switch electrically connect the second antenna to the transceiver via the first transmission line or the second transmission line based on input from the antenna controller.

10. The adaptive antenna array of claim 9, wherein the second transmission line's length is greater than the first transmission line's length.

11. The adaptive antenna array of claim 10, wherein the second transmission line's length introduces a phase delay of approximately 90 degrees as compared to the first transmission line's length at a frequency of approximately 2.4 GHz.

12. The adaptive antenna array of claim 11, wherein the radiation pattern of the adaptive antenna is at least 5 dBi greater in a first direction when the second transmission line is electrically connected as compared to the first transmission line and the radiation pattern of the adaptive antenna is at least 5 dBi greater in a second direction when the first transmission line is electrically connected as compared to the second transmission line.

13. The adaptive antenna array of claim 8, wherein the phase control component comprises an array of capacitors, wherein the antenna controller controls the electrical connection of the array of capacitors between the second antenna and the transceiver.

14. The adaptive antenna array of claim 13, wherein the first electrical connection further comprises a second phase control component that is present between the first antenna and the transceiver.

15. The adaptive antenna array of claim 8, wherein the antenna controller is configured to: determine a first signal strength when phase control component is set to a first mode; determine a second signal strength when the phase control component is set to a second mode; compare the first signal strength and the second signal strength to determine the first signal strength is greater; and cause, for at least a period of time, the phase control component to be set to the first mode.

16. An adaptive antenna system, comprising:
an adaptive antenna, comprising:
a first radiating element having a first length, wherein the first length of the first radiating element corresponds to a first harmonic of a frequency;
a second radiating element having a second length, wherein the second length of the second radiating element corresponds to a second or higher harmonic of the frequency;
a switch that alternatively connects a transceiver with the first radiating element or the second radiating element, wherein the transceiver transmits or receives at the frequency; and
an antenna controller that controls actuation of the switch between the first radiating element and the second radiating element, wherein a radiation pattern varies at a particular frequency based on whether the first radiating element or the second radiating element is electrically connected with the transceiver via the switch.

17. The adaptive antenna system of claim 16, wherein the frequency is 2.4 GHz.

18. The adaptive antenna system of claim 16, wherein the second length of the second radiating element corresponds to a third harmonic of the frequency.

19. The adaptive antenna system of claim 16, wherein the antenna control is configured to: determine a first signal metric when the first radiating element is electrically connected with the transceiver via the switch; determine a second signal metric when the second radiating element is electrically connected with the transceiver via the switch; compare the first signal metric and the second signal metric to determine if the first signal strength is greater; and cause, for at least a period of time, the switch to connect the transceiver with the first radiating element based on determining the first signal metric is greater.

20. The adaptive antenna system of claim 19, wherein the signal metric is selected from the group consisting of: received signal strength (RSSI), signal to noise ratio (SNR), and data throughput.
